(19) United States
(12) Patent Application Publication
(10) Pub. No.: US 2025/0361639 A1
(43) Pub. Date: Nov. 27, 2025

(54) ELECTROCHEMICAL EXTRACTION OF TARGET CATIONS FROM COMPLEX RESOURCES

(71) Applicant: The Regents of the University of California, Oakland, CA (US)

(72) Inventors: Gaurav N. Sant, Los Angeles, CA (US); David Jassby, Los Angeles, CA (US); Xin Chen, Los Angeles, CA (US); Dante Simonetti, Los Angeles, CA (US)

(21) Appl. No.: 18/875,051

(22) PCT Filed: Jun. 16, 2023
(86) PCT No.: PCT/US23/25526

§ 371 Date: Dec. 13, 2024

Related U.S. Application Data
(60) Provisional application No. 63/352,772, filed on Jun. 16, 2022.

(51) Int. Cl. C25C 1/02; C25B 1/04; C25B 1/26; C25B 9/19; C25C 1/08; C25C 1/10; C25C 7/06

(52) U.S. Cl. CPC C25C 1/02; C25B 1/04; C25B 1/26; C25B 9/19; C25C 1/08; C25C 1/10; C25C 7/06

(57) ABSTRACT

The present disclosure relates to a method of extracting and isolating a target cation from precursors containing a mixture of cation species.

### CROSS-REFERENCE TO RELATED APPLICATIONS

This application claims the benefit of priority to U.S. Provisional Application No. 63/352,772, filed on Jun. 16, 2022, the contents of which are hereby incorporated by reference in their entirety.

### STATEMENT REGARDING FEDERALLY SPONSORED RESEARCH

This invention was made with government support under Grant Number DE-EE0008391 awarded by the Department of Energy. The government has certain rights in the invention.

### BACKGROUND

The industrial demands for lithium have surged amid the increasing numbers of electric vehicles and lithium-ion batteries (LIB). Production of lithium, on the other hand, is limited by the location and complexity of Li-sources, and technological maturity of Li-recovery processes. The prevailing lithium production/recovery from brines, Li-ores, and recycled LIB cathodes are of high cost and low efficiency, and multiple Li-separation and evaporation steps are often involved). The mainstream lithium extraction techniques, such as lithium production from Li-ores, consume vast quantities of sulfuric acids, and require extensive heating to precipitate Li₂CO₃. Rioyo, J.; Tuset, S.; Grau, R. Lithium Extraction from Spodumene by the Traditional Sulfuric Acid Process: A Review. Mineral Processing and Extractive Metallurgy Review 2020, 1-10.

Accordingly, there is a need for processes for obtaining lithium and other industrially important metals without using safer and that are less energy-intensive

### SUMMARY OF THE INVENTION

The present disclosure provides, in certain embodiments, a method of extracting and isolating a target cation comprising:
(i) providing feed electrolyte to a water-splitting reactor comprising an anode and cathode;
(ii) electrochemically producing an aqueous acid solution;
(iii) providing the aqueous acid solution and a precursor comprising the target cation to a decomplexation tank, and decomplexing the precursor with the acid solution to form a decomplexed solution; and
(iv) separating the target cation from the decomplexed solution.

### BRIEF DESCRIPTION OF THE DRAWINGS

FIG. 1. Is a schematic depicting an exemplary extraction process according to some embodiments of the present invention.

FIGS. 2A-2C FIG. 2A depicts an and exemplary Li separator, whereby electron field, pressure difference, or osmotic pressure difference drives Li+ ions to cross a Lithium Ion Sieve (LIS) membrane, while other ions are rejected A photograph of an (LIS) membrane useful in the present process is shown in FIG. 2B, and the one-pass Li-selectivity of this membrane is illustrated in FIG. 2C.

### DETAILED DESCRIPTION OF THE INVENTION

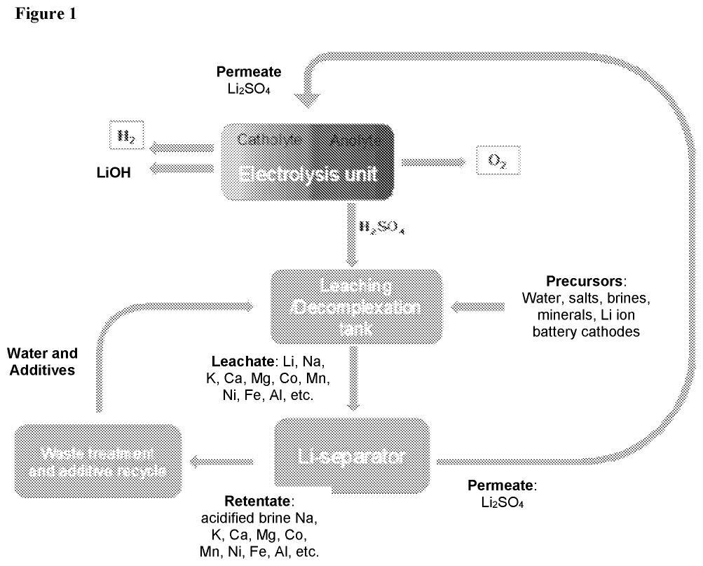

The strategic scheme (FIG. 1) depicts an exemplary method for LiOH production according to the following steps: 1) electrochemical acid-alkaline production, 2) acid-facilitated leaching, decomposition, and decomplexation of Li-containing precursors, and 3) Li-selective separation. The electrochemical acid-alkali process can be either membrane-containing, or membrane-less electrolysis and/or electrodialysis reactors, wherein water is electrochemically split into H⁺ and OH⁻ ions. Therefore, the reactor includes an acid and an alkaline electrolyte. The present methods advantageously provide in certain embodiments an energy-effective, high-throughput electrochemical pathway to extract lithium from complex Li-containing resources without acid addition, yielding LiOH as the product accompanied by valuable byproducts such as hydrogen.

In certain embodiments, methods of extracting and isolating a target cation comprise:
(i) providing feed electrolyte to a water-splitting reactor comprising an anode and cathode;
(ii) electrochemically producing an aqueous acid solution;
(iii) providing the aqueous acid solution and a precursor comprising the target cation to a decomplexation tank, and decomplexing the precursor with the acid solution to form a decomplexed solution; and
(iv) separating the target cation from the decomplexed solution.

In certain embodiments, the precursor comprises salts, minerals, brines, electronic components, battery components, industrial waste streams, mine tailings, seawater, or any combination thereof. In certain embodiments, the precursor comprises the target cation paired with an anion selected from halide, oxide, sulfate, sulfite, nitrate, nitrite, chlorate, chlorite, perchlorate, and any combination thereof. In certain embodiments, the precursor comprises the target cation paired with a halide. In certain embodiments, the precursor comprises the target cation paired with an oxide. In certain preferred embodiments, the precursor comprises the target cation paired with a sulfate. In certain embodiments, the precursor comprises the target cation paired with a nitrate. In certain embodiments, the precursor comprises the target cation paired with a nitrite. In certain embodiments, the precursor comprises the target cation paired with a chlorate. In certain embodiments, the precursor comprises the target cation paired with a chlorite. In certain embodiments, the precursor comprises the target cation paired with a perchlorate. In certain embodiments, the precursor comprises the target cation paired with a combination of anions selected from halide, oxide, sulfate, sulfite, nitrate, nitrite, chlorate, chlorite, and perchlorate.

In certain embodiments, the brine is a continental brine, a geothermal brine, or an oil field brine. Continental brine deposits are found in underground reservoirs, typically in locations with arid climates. Such brines are contained within a closed basin, with the surrounding rock formations being the source of the dissolved constituents in the brine. Geothermal brine deposits are found in rocky underground formations with high heat flows. Geothermal brines may be highly concentrated, often with significant dissolved metal content. Oil field brine deposits may be generated from lands with underground petroleum reserves. In extracting oil and gas from oil fields, a significant amount of brine is also brought to the surface as well. These brines are often rich in dissolved metals, which can include lithium in some locations.

In certain embodiments, a brine solution contains Li ions and at least one additional metal cation. In some such embodiments, the additional metal cation is a non-target cation. In various embodiments, the additional cation is a monovalent cation, a divalent cation, or a combination thereof. In various embodiments, the monovalent cation is an alkali metal ion (e.g., one or more cations of Na, K, Rb, Cs). In certain embodiments, the multivalent ion is a divalent ion such as Ca²⁺ or Mg²⁺.

In certain embodiments, the target cation is selected from a cation of Li, Na, K, Ca, Mg, Co, Mn, Ni, Fe, Al, and any combination thereof, while in certain preferred embodiments, the target cation is Li+.

In certain embodiments, the alkaline electrolyte is an electrolyte solution, such as an aqueous solution, with a basic pH configured to flow around or through a cathode which may comprise a negative charge. In certain embodiments, the acidic electrolyte may be an electrolyte solution configured to flow around or through an anode which may comprise a positive charge. In certain embodiments, the alkaline electrolyte and acidic electrolyte may be configured to be separated by a bipolar membrane process. In further embodiments, the acidic and alkaline electrolytes are separated by a porous diaphragm. In yet further embodiments, the acidic and alkaline electrolytes are separated by an ion exchange membrane. In certain embodiments, the feed electrolyte may comprise a brine. In certain embodiments, the brine comprises lithium salts (e.g., solutions of LiCl, Li₂SO₄, LiClO₄, etc.).

In certain embodiments, LiOH and acid (e.g., HCl, H₂SO₄, HClO₄, HNO₃, or an organic acid) solutions, which may further comprise chelators, are produced after an electrochemical acid-alkali process. In certain such embodiments, the chelators may include, as non-limiting examples, at least one of ethylene glycol-bis-aminoethyl ether)-N,N,N′,N′-tetraacetic acid, ethylenediaminetetraacetic acid, hydroxyethylethylenediaminetriacetic acid, nitrilotriacetic acid, diphenylamine, azodicarbonamide, citrate, oxalic acid, and any other organic acid or molecule that functions as a target ion chelator. In certain embodiments, hydrogen gas (H₂) is produced at the cathode and oxygen/chlorine gas (O₂/Cl₂) is produced at the anode.

In certain embodiments, Li-extraction can be achieved by the leaching process using an electrochemically produced acid. The acid can promote dissolution, decomposition, and/or decomplexation of Li-containing precursors (e.g., sourced from natural or artificial brines, minerals, ores, and recycled lithium ion battery cathodes), and form decomplexed solutions containing the target cation (e.g., Li⁺) and other metal ions (including but not limited to ions of Na, K, Ca, Mg, Mn, Co, Ni, Fe, Al). In certain embodiments, the leaching process might be acid-facilitated.

In certain embodiments, the leaching process might be accelerated by one or more stimuli such as heating, stirring, and/or ultrasonication. For example, in certain embodiments, ultrasonic stimulation is performed at a frequency of about 18 kHz to about 2000 kHz. In various embodiments, the ultrasonic stimulation frequency is about 20 kHz to about 40 kHz. In various embodiments, the ultrasonic stimulation frequency is about 800 kHz to about 1200 kHz. In various embodiments, the ultrasonic stimulation frequency is greater than or equal to about 18 kHz. In various embodiments, the ultrasonic stimulation frequency is less than or equal to about 2000 kHz. In various embodiments, the ultrasonic stimulation frequency is about 20 kHz. In various embodiments, the ultrasonic stimulation frequency is about 30 kHz. In various embodiments, the ultrasonic stimulation frequency is about 40 kHz. In various embodiments, the ultrasonic stimulation frequency is about 50 kHz. In various embodiments, the ultrasonic stimulation frequency is about 60 kHz. In various embodiments, the ultrasonic stimulation frequency is about 70 kHz. In various embodiments, the ultrasonic stimulation frequency is about 80 kHz. In various embodiments, the ultrasonic stimulation frequency is about 90 kHz. In various embodiments, the ultrasonic stimulation frequency is about 100 kHz. In various embodiments the ultrasonic stimulation frequency is about 200 kHz. In various embodiments, the ultrasonic stimulation frequency is about 300 kHz. In various embodiments, the ultrasonic stimulation frequency is about 400 kHz. In various embodiments, the ultrasonic stimulation frequency is about 500 kHz. In various embodiments, the ultrasonic stimulation frequency is about 600 kHz. In various embodiments, the ultrasonic stimulation frequency is about 700 kHz. In various embodiments, the ultrasonic stimulation frequency is about 800 kHz. In various embodiments, the ultrasonic stimulation frequency is about 900 kHz. In various embodiments, the ultrasonic stimulation frequency is about 1000 kHz (1 MHZ). In various embodiments, the ultrasonic stimulation frequency is about 1100 kHz (1.1 MHz). In various embodiments, the ultrasonic stimulation frequency is about 1200 kHz (1.2 MHz). In various embodiments, the ultrasonic stimulation frequency is about 1300 kHz (1.3 MHz). In various embodiments, the ultrasonic stimulation frequency is about 1400 kHz (1.4 MHz). In various embodiments, the ultrasonic stimulation frequency is about 1500 kHz (1.5 MHz). In various embodiments, the ultrasonic stimulation frequency is about 1600 kHz (1.6 MHz). In various embodiments, the ultrasonic stimulation frequency is about 1700 kHz (1.7 MHz). In various embodiments, the ultrasonic stimulation frequency is about 1800 kHz (1.8 MHz). In various embodiments, the ultrasonic stimulation frequency is about 1900 kHz (1.9 MHz). In various embodiments, the ultrasonic stimulation frequency is about 2000 kHz (2 MHZ).

In various embodiments, the ultrasonic stimulation is provided by a sonic probe that is at least partially submerged in the solution. In various embodiments, the ultrasonic stimulation is provided by one or more ultrasonic plates in contact with the reactor. In still further embodiments, the ultrasonic stimulation is provided by both a sonic (e.g., ultrasonic) probe and a sonic (e.g., ultrasonic) plate. In various embodiments, the sonic probe causes agitation of the solvent due to the rapid motion of the probe. In various embodiments, particularly where the ultrasonic plate is used for sonic stimulation, a stirrer may be disposed within the reactor to ensure thorough mixing of the solvent. In various embodiments, an effluent liquid stream from the reactor is enriched in the target metal (e.g., Li, Mg and/or Ca). In various embodiments, as the solid substrate to-be-leached contains other less-soluble elements (i.e., non-target materials), such as silicon (Si) and aluminum (Al), a portion of the solid substrate remains undissolved, and may be removed as spent solid. In various embodiments, the spent solid is passed through a spent solid outlet.

In various embodiments, ultrasonic stimulation of the solid particles within the substrate-solvent mixture allows for larger particle sizes to be effective for leaching compared to acid leaching, lowering any required grinding energy of the process. In various embodiments, the particles may be about 100 μm or greater. In various embodiments, the particles have an average diameter of about 500 nm to 5 mm, about 100 μm to about 5 mm, about 500 μm to about 5 mm, or about 500 μm to about 3 mm. In various embodiments, the leaching tank may be operated as a continuous flow reactor. In various embodiments, the leaching tank may be operated as a batch reactor. In various embodiments, the leaching tank may be operated as a plug flow reactor (PFR) mode. In various embodiments, the leaching tank may be operated as a fixed- or fluidized-bed reactor. In various embodiments, the particular choice of mode may depend on dissolution rate of the target metal, as well as the operational nature of the downstream application(s) for the lithium- and/or magnesium-rich stream. In various embodiments, the substrate includes lizardite, antigorite, basalt, spodumene, forsterite, enstatite, merwinite, petalite, lepidolite, eucryptite, and/or virgilite.

Other additives (including but not limited to water, salts such as NaCl, Na₂SO₄, NaClO₄) can be added during leaching to improve the electric conductivity of the decomplexed solution. In certain embodiments, methods of the disclosure further comprise adding water or a salt to the decomplexed solution, wherein the salt comprises at least one of LiCl, LiNO₃, Li₂SO₄, LiClO₄, NaCl, NaNO₃, Na₂SO₄, NaClO₄, KCl, KNO₃, K₂SO₄, and KClO₄. In certain such embodiments, the salt comprises LiCl. In certain embodiments, the salt comprises LiNO₃. In certain embodiments, the salt comprises Li₂SO₄. In certain embodiments, the salt comprises LiClO₄. In certain embodiments, the salt comprises NaCl. In certain embodiments, the salt comprises NaNO₃. In certain embodiments, the salt comprises Na₂SO₄. In certain embodiments, the salt comprises NaClO₄. In certain embodiments, the salt comprises KCl. In certain embodiments, the salt comprises KNO₃. In certain embodiments, the salt comprises K₂SO₄. In certain embodiments, the salt comprises KClO₄. In certain embodiments, methods of the disclosure further comprise adding a combination of salts selected from LiCl, LiNO₃, Li₂SO₄, LiClO₄, NaCl, NaNO₃, Na₂SO₄, NaClO₄, KCl, KNO₃, K₂SO₄, and KClO₄. In certain preferred embodiments, methods of the disclosure further comprise adding water to the decomplexed solution.

In certain embodiments, a defluorination treatment is applied to the decomplexed solution to remove fluorine and/or fluoride containing compounds.

In certain embodiments, the acidic solution comprises HCl, H₂SO₄, HClO₄, HNO₃, an organic acid, or any combination thereof. In certain embodiments, the acidic solution comprises HCl. In certain preferred embodiments, the acidic solution comprises H₂SO₄. In further embodiments, the acidic solution comprises HClO₄. In yet further embodiments, the acidic solution comprises HNO₃. In still further embodiments, the acidic solution comprises an organic acid. In certain embodiments, the acidic solution comprises a combination of HCl, H₂SO₄, HClO₄, HNO₃ and an organic acid.

In certain embodiments, step (ii) of the method further comprises electrochemically producing an aqueous base solution. The aqueous base solution may comprises, in certain embodiments, a hydroxide salt of the target cation.

In certain embodiments, the decomplexed solution comprises the target cation and at least one non-target metal cation. The non-target metal cation may include, in certain embodiments, a cation of Na, K, Ca, Mg, Mn, Co, Ni, Fe, Al, or any combination thereof. In certain embodiments, the at least one non-target metal cation is a cation of Na. In further embodiments, the at least one non-target metal cation is a cation of K. In yet further embodiments, the at least one non-target metal cation is a cation of Ca. In still further embodiments, the at least one non-target metal cation is a cation of Mg. In certain embodiments, the at least one non-target metal cation is a cation of Mn. In further embodiments, the at least one non-target metal cation is a cation of Co. In yet further embodiments, the at least one non-target metal cation is a cation of Ni. In still further embodiments, the at least one non-target metal cation is a cation of Fe. In certain embodiments, the at least one non-target metal cation is a cation of Al.

In certain embodiments, LiOH and acid (e.g., HCl, H₂SO₄, HClO₄, HNO₃, etc.) solutions are produced after an electrochemical acid-alkali process. In certain embodiments, hydrogen gas (H₂) will be produced at the cathode and oxygen/chlorine gas (O₂/Cl₂) will be produced at the anode.

In certain embodiments, Li-extraction can be achieved by the leaching process using an electrochemically produced acid. The acid can promote dissolution, decomposition, and decomplexation of Li-containing precursors (e.g., sourced from natural or artificial brines, minerals, ores, and recycled lithium ion battery cathodes), and form decomplexed solutions containing Li⁺ and other metal ions (including but not limited to ions of Na, K, Ca, Mg, Mn, Co, Ni, Fe, Al). In certain embodiments, the leaching process might be acid-facilitated.

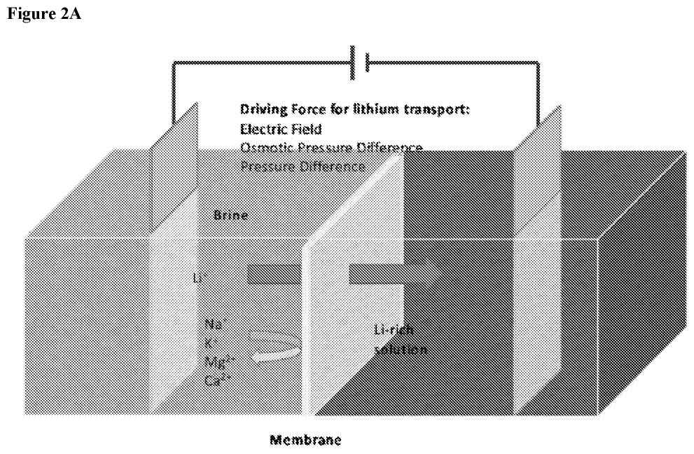

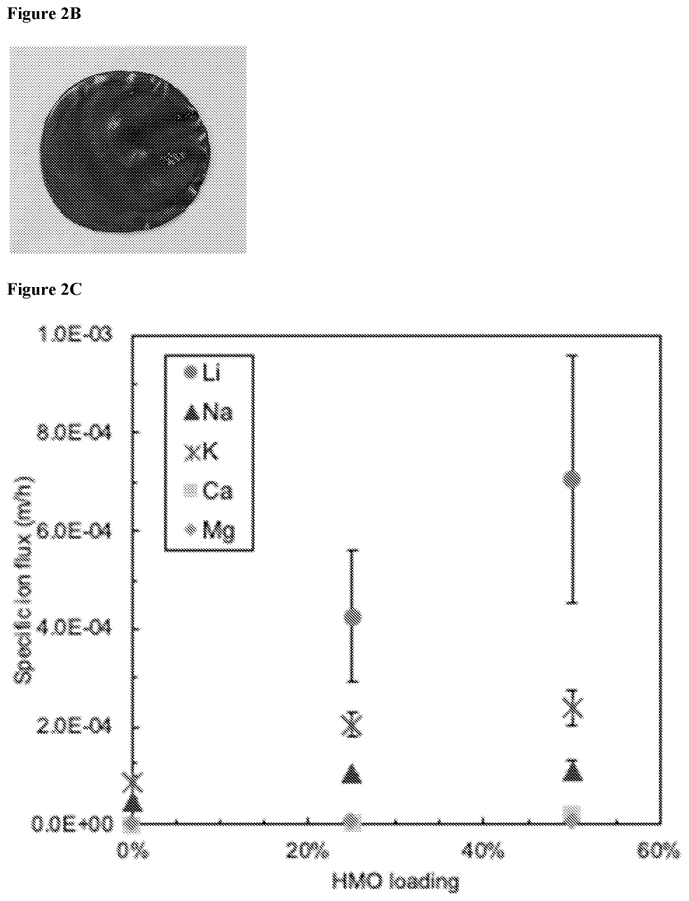

Once the lithium is extracted into the decomplexed solutions, it can be separated from other metal ions by using a separation process. In certain embodiments, the separation is achieved by using a lithium ion-sieve (LIS) membrane separator (FIG. 2B). In this apparatus, the applied field(s) (electro-motive, pressure difference, and/or osmotic pressure difference) across the LIS membrane drives Li⁺ ions to permeate while non-target ions (e.g., ions of Na, K, Ca, Mg, Mn, Co, Ni, Fe, Al) are rejected. The selectivity of an exemplary LIS membrane is illustrated in FIG. 2C (acquired from a single-pass experiment) and Table 1 below.

TABLE 1
Ion selectivity of the LIS membrane demonstrated using a
brine solution comprising 0.003M of Li₂SO₄, 0.217M of
Na₂SO₄, 0.018M of K₂SO₄, 0.008M of CaSO₄, and 0.017M
of MgSO₄, ∞ indicates that there was no competing ion flux.

| | | |
|---|---|---|
| Ion selectivity | Li/Na | 6.2 ± 1.1 |
| | Li/K | 2.9 ± 0.7 |
| | Li/Ca | ∞ |
| | Li/Mg | ∞ |

In various embodiments, the ion-selective separation membrane includes any suitable embedded particles (e.g., ions) that foster specific interactions with the target metal ions (e.g., monovalent ions). In various embodiments, the ion-selective separation membrane is formed with any suitable adsorbent (e.g., a metal ion adsorbent) that is configured to allow transport of target ions through the membrane under the influence of an applied electric potential difference while non-target ions are not able (e.g., are too large) to pass through the membrane. In various embodiments, the target ion includes at least one of: an alkali metal (lithium, sodium, potassium, rubidium, cesium, francium), an alkaline earth metal (beryllium, magnesium, calcium, strontium, barium, radium), a transition metal (scandium, titanium, vanadium, chromium, manganese, iron, cobalt, nickel, copper, zinc, yttrium, zirconium, niobium, molybdenum, technetium, ruthenium, rhodium, palladium, silver, cadmium, lutetium, hafnium, tantalum, tungsten, rhenium, osmium, iridium, platinum, gold, mercury, lawrencium, rutherfordium, dubnium, seaborgium, bohrium, hassium, meitnerium, darmstadtium, roentgenium, copernicium), a post-transition metal (aluminum, gallium, indium, tin, thallium, lead, bismuth, nihonium, flerovium, moscovium, livermorium, tennessine, oganesson), a lanthanide (lanthanum, cerium, praseodymium, neodymium, promethium, samarium, europium, gadolinium, terbium, dysprosium, holmium, erbium, thulium, ytterbium, lutetium), an actinide (actinium, thorium, protactinium, uranium, neptunium, plutonium, americium, curium, berkelium, californium, einsteinium, fermium, mendelevium, nobelium, lawrencium), and/or a superactinide. In various embodiments, the ion-selective separation membrane selectively separates a target monovalent ion from a polar solution containing the target ion and at least one competing ion. In various embodiments, the competing ion may be another monovalent ion such as Na, K, Rb, Cs, a divalent ion such as Ca²⁺ or Mg²⁺, or any combination of mono- and divalent ions.

After the separation process, the subsequent permeate comprises primarily Li-salt, and can be fed to the electrolysis and/or electrodialysis processes to further convert lithium as LiOH, while other metal ions remain primarily in the retentate. Multivalent metal ions in the retentate (e.g., ions of Ca, Mg, Mn, Co, Ni, Fe, Al) can be removed, e.g., by subsequent separation processes, thereby allowing recycling of the water and additive salts induced during the leaching process. In certain embodiments, removal may be achieved via a precipitation-sedimentation process induced by either a pH-swing (e.g., by adding NaOH), or a carbonation process (e.g., by adding Na₂CO₃). In certain embodiments, this is achieved by passing the retentate through a nanofiltration (NF) system.

In certain embodiments, methods of the disclosure may further comprise separating a second target cation from the decomplexed solution. In certain embodiments, methods of the disclosure may comprise separating a third target cation from the decomplexed solution.

### Definitions

Unless otherwise defined herein, scientific and technical terms used in this application shall have the meanings that are commonly understood by those of ordinary skill in the art. Generally, nomenclature used in connection with, and techniques of, chemistry, electrochemistry, chemical engineering, civil engineering and environmental engineering, described herein, are those well-known and commonly used in the art.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

The terms “a,” “an,” and “the” include plural referents unless the context clearly dictates otherwise. Thus, for example, reference to an object can include multiple objects unless the context clearly dictates otherwise.

As used herein, the terms “substantially,” “substantial,” “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to #10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

As used herein, the terms “decomplexing,” refers to a process of removing (a) metal atom(s) from a precursor comprising the metal atom(s), including optionally oxidizing the metal atom(s), preferably using an acidic aqueous solution, thereby forming metal cations, which may, in certain embodiments, dissolve in the acidic aqueous solution. In certain embodiments, “decomplexing,” or “decomplexation” may be performed on solid or aqueous precursors, or both, including but not limited to: brines (including seawater), salts, minerals, electronic components, battery components, industrial waste streams, mine tailings, seawater, or any combination thereof. In certain embodiments, the precursor is a solid and the term “decomplexing,” may be used interchangeably with “leaching” of the precursor by an aqueous solution. In certain embodiments, decomplexing includes decomposition of the precursor. In certain embodiments, decomplexing includes both leaching and decomposition.

The term “decomplexed solution” as used herein refers to a solution produced via decomplexing one or more precursors. In certain embodiments, “decomplexed solution” may refer to such a solution comprising one or more metal cations. In preferred embodiments, the decomplexed solution comprises the target cation, water, and one or more non-target cations. A decomplexed solution also may, in certain embodiments, refer to a leachate.

The term “organic acid,” as used herein, refers to a chemical compound that features at least one carbon atom and meets at least one definition of an acid well-known in the art (e.g., Lewis acid, Bronsted-Lowry acid, Arrhenius acid). As non-limiting examples, organic acids relevant to the methods of the present disclosure may include carboxylic acids, alkylammonium species, and phenols or other hydroxyl-substituted molecules. In certain embodiments, the term “organic acid” may also refer to perhalogenated carbon-containing molecules, e.g., triflates or trifluoromethane sulfonates and perfluorinated carboxyacids (including trifluoroacetic acid).

### EXAMPLES

The invention now being generally described, it will be more readily understood by reference to the following examples which are included merely for purposes of illustration of certain aspects and embodiments of the present invention and are not intended to limit the invention.

### Example 1: Preparation of Exemplary Li-Selective Membranes

In certain embodiments, methods of the present disclosure include the use of Li-selective membranes. Exemplary Li-selective membranes may be prepared according to the following procedure. Suitable Li-selective membranes may also be found in, e.g., published PCT Application No. PCT/US2022/049102, the contents of which are fully incorporated by reference herein, and in particular for the membranes disclosed therein.

Step 1: Lithium manganese oxide (LMO) was prepared by heat-treating lithium manganese dioxide (LiMnO₂) powder at 450° C. in air. The LMO was delithiated for 24 hours via Li+/H+ ion exchange. 1.5 g of LMO was dispersed in 1.5 L of a strong acid (e.g., 0.5 M HCl) to obtain the lithium adsorbent H_{1.10}Li_{0.08}Mn_{1.73}O_{4.05} (HMO). Then the HMO particle was thoroughly washed with deionized (DI) water until neutral pH was achieved and then dried at 50° C. in the oven.

Step 2: HMO particles were dispersed in an anion exchange polymer solution at a certain mass ratio by sonicating the mixture for 30 seconds in ice bath. Three types of membranes were fabricated with HMO loading of 10%, 25% and 50% (corresponding HMO-polymer ratio of 0.1:1, 0.25:1, 0.5:1).

Step 3: Anion exchange membranes containing HMO (HMO-AEM) were synthesized by evaporating solvent of HMO-polymer mixture at 80° C. in the oven for 20 hours. The prepared HMO-AEM membranes were soaked in testing solution for 24 h and then DI water for 2 h prior to performance tests.

Step 4. The HMO-AEM membrane was clamped between two glass diffusion cells. An electrical potential difference was applied as the driving force. The membrane performance was tested under constant current (0.1 A) condition for 75 minutes. The membranes were tested with two types of feed solution: Feed A contains equal molar of Na₂SO₄ (0.017 M), Li₂SO₄ (0.017 M), and MgSO₄ (0.017 M); Feed B contains more common competing cations including Na⁺, K⁺, Ca²⁺ and Mg²⁺ and the cation ratio mimics the ratio in a real geothermal brine (Westmorland). Feed B was prepared such that its ionic strength and sulfate concentration are equivalent to Feed A. That is, 0.003 M of Li₂SO₄, 0.217 M of Na₂SO₄, 0.018 M of K₂SO₄, 0.008 M of CaSO₄, and 0.017 M of MgSO₄.

### Example 2: Exemplary Demonstration of Ion Selectivity of an Exemplary Membrane

Ion selectivity of the LIS membrane is demonstrated using a synthetic brine solution comprising 0.017 M of Li₂SO₄, 0.017 M of Na₂SO₄, and 0.017 M of MgSO₄, or a real brine solution containing 67 mM Li, 3,600 mM Na, 170 mM K, 134 mM Mg, and 1,021 mM Ca; ∞ indicates that there was no competing ion flux.

TABLE 2

| | | |
|---|---|---|
| Ion | Li/Na | 312 |
| selectivity | Li/Ca | 4083 |
| | Li/Mg | ∞ |
| | Li/K | 101 |

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A method of extracting and isolating a target cation comprising:
(i) providing feed electrolyte to a water-splitting reactor comprising an anode and cathode;
(ii) electrochemically producing an aqueous acid solution;
(iii) providing the aqueous acid solution and a precursor comprising the target cation to a decomplexation tank, and decomplexing the precursor with the acid solution to form a decomplexed solution; and
(iv) separating the target cation from the decomplexed solution.

2. The method of claim 1, wherein the precursor comprises one or more salts, minerals, brines, electronic components, battery components, industrial waste streams, mine tailings, seawater, or any combination thereof.

3. The method of claim 2, wherein the precursor comprises a salt.

4. The method of claim 2 or 3, wherein the precursor comprises a brine.

5. The method of any one of claims 2-4, wherein the precursor comprises a mineral.

6. The method of any one of claims 1-5, wherein the precursor comprises the target cation paired with an anion selected from halide, oxide, sulfate, sulfite, nitrate, nitrite, chlorate, chlorite, perchlorate, and any combination thereof.

7. The method of claim 6, wherein the precursor comprises the target cation paired with a halide.

8. The method of claim 6, wherein the precursor comprises the target cation paired with an oxide.

9. The method of claim 6, wherein the precursor comprises the target cation paired with a sulfate.

10. The method of claim 6, wherein the precursor comprises the target cation paired with a nitrate.

11. The method of claim 6, wherein the precursor comprises the target cation paired with a nitrite.

12. The method of claim 6, wherein the precursor comprises the target cation paired with a chlorate.

13. The method of claim 6, wherein the precursor comprises the target cation paired with a chlorite.

14. The method of claim 6, wherein the precursor comprises the target cation paired with a perchlorate.

15. The method of any one of claims 1-14, wherein the precursor comprises the target cation paired with one or more anions selected from halide, oxide, sulfate, sulfite, nitrate, nitrite, chlorate, chlorite, and perchlorate.

16. The method of any one of claims 1-15, wherein the target cation is a cation of a metal selected from groups 1-13, lanthanide, and actinide.

17. The method of any one of claims 1-16, wherein the target cation is selected from a cation of Li, Na, K, Ca, Mg, Co, Mn, Ni, Fe, Al, and any combination thereof.

18. The method of claim 17, wherein the target cation is Li⁺.

19. The method of any one of claims 1-18, wherein the water-splitting reactor comprises an acidic electrolyte and an alkaline electrolyte.

20. The method of claim 19, wherein the acidic electrolyte flows around or through the anode.

21. The method of claim 19 or 20, wherein the alkaline electrolyte flows around or through the cathode.

22. The method of any one of claims 19-21, wherein the acidic and alkaline electrolytes are separated by a dividing membrane selected from a porous diaphragm, an ion exchange membrane, or a bipolar membrane.

23. The method of claim 22, wherein the acidic and alkaline electrolytes are separated by a porous diaphragm.

24. The method of claim 22, wherein the acidic and alkaline electrolytes are separated by an ion exchange membrane.

25. The method of claim 22, wherein the acidic and alkaline electrolytes are separated by a bipolar membrane.

26. The method any one of claims 1-25, wherein the decomplexed solution comprises a salt of the target cation.

27. The method of any one of claims 1-26, wherein the aqueous acid solution comprises HCl, HNO₃, H₂SO₄, HClO₄, an organic acid or any combination thereof.

28. The method of claim 27, wherein the aqueous acid solution comprises HCl.

29. The method of claim 27, wherein the aqueous acid solution comprises HNO₃.

30. The method of claim 27, wherein the aqueous acid solution comprises H₂SO₄.

31. The method of claim 27, wherein the aqueous acid solution comprises HClO₄.

32. The method of claim 27, wherein the aqueous acid solution comprises an organic acid.

33. The method of claim 27, wherein the aqueous acid solution comprises a combination of acids selected from HCl, HNO₃, H₂SO₄, HClO₄, and an organic acid.

34. The method of any one of claims 1-33, wherein step (ii) further comprises electrochemically producing an aqueous base solution.

35. The method of claim 34, wherein the aqueous base solution comprises a hydroxide salt of the target cation.

36. The method of any one of claims 1-35, wherein H₂ is produced at the cathode of the electrolysis reactor.

37. The method of any one of claims 1-36, wherein O₂ is produced at the anode of the electrolysis reactor.

38. The method of any one of claims 1-37, wherein Cl₂ is produced at the anode of the electrolysis reactor.

39. The method of any one of claims 1-38, wherein step (iii) further comprises at least one of leaching and decomposing the precursor.

40. The method of any one of claims 1-39, wherein the decomplexed solution comprises the target cation and at least one non-target metal cation.

41. The method of any one of claims 1-40, wherein at least one non-target metal cation is selected from a cation of Na, K, Ca, Mg, Mn, Co, Ni, Fe, Al, or any combination thereof.

42. The method of claim 41, wherein at least one non-target metal cation is a cation of Na (e.g., Na⁺).

43. The method of claim 41, wherein at least one non-target metal cation is a cation of K (e.g., K⁺).

44. The method of claim 41, wherein at least one non-target metal cation is a cation of Ca (e.g., Ca²⁺).

45. The method of claim 41, wherein at least one non-target metal cation is a cation of Mg (e.g., Mg²⁺).

46. The method of claim 41, wherein at least one non-target metal cation is a cation of Mn (e.g., Mn²⁺).

47. The method of claim 41, wherein at least one non-target metal cation is a cation of Co (e.g., Co²⁺ or Co³⁺).

48. The method of claim 41, wherein at least one non-target metal cation is a cation of Ni (e.g., Ni²⁺).

49. The method of claim 41, wherein at least one non-target metal cation is a cation of Fe (e.g., Fe²⁺ or Fe³⁺).

50. The method of claim 41, wherein at least one non-target metal cation is a cation of Al (e.g., Al³⁺).

51. The method of any one of claims 1-50, further comprising at least one of heating, stirring, mechanically agitating, and ultrasonicating the decomplexed solution.

52. The method of any one of claims 1-51, further comprising adding water or a salt to the decomplexed solution, wherein the salt comprises at least one of LiCl, LiNO₃, Li₂SO₄, LiClO₄, NaCl, NaNO₃, Na₂SO₄, NaClO₄, KCl, KNO₃, K₂SO₄, and KClO₄.

53. The method of claim 52, wherein the salt comprises LiCl.

54. The method of claim 52, wherein the salt comprises LiNO₃.

55. The method of claim 52, wherein the salt comprises Li₂SO₄.

56. The method of claim 52, wherein the salt comprises LiClO₄.

57. The method of claim 52, wherein the salt comprises NaCl.

58. The method of claim 52, wherein the salt comprises NaNO₃.

59. The method of claim 52, wherein the salt comprises Na₂SO₄.

60. The method of claim 52, wherein the salt comprises NaClO₄.

61. The method of claim 52, wherein the salt comprises KCl.

62. The method of claim 52, wherein the salt comprises KNO₃.

63. The method of claim 52, wherein the salt comprises K₂SO₄.

64. The method of claim 52, wherein the salt comprises KClO₄.

65. The method of any one of claims 52-64, wherein the salt comprises a combination of salts selected from LiCl, LiNO₃, Li₂SO₄, LiClO₄, NaCl, NaNO₃, Na₂SO₄, NaClO₄, KCl, KNO₃, K₂SO₄, and KClO₄.

66. The method of any one of claims 1-65, further comprising defluorinating the decomplexed solution.

67. The method of any one of claims 1-66, step (iv) further comprising passing the decomplexed solution through a separation membrane.

68. The method of claim 67, further comprising passing the decomplexed solution through the separation membrane at least twice.

69. The method of claim 67 or 68, wherein the separation membrane is a lithium ion sieve.

70. The method of any one of claims 1-69, wherein step (iv) produces a permeate solution comprising the target cation.

71. The method of claim 70, wherein the feed electrolyte comprises the permeate solution.

72. The method of any one of claims 1-71, wherein step (iv) produces a retentate solution comprising the at least one non-target metal cation.

73. The method of claim 72, further comprising recycling the non-target cations from the retentate.

74. The method of claim 73, wherein recycling the non-target ions from the retentate comprises a precipitation-sedimentation process induced by a pH change or carbonation.

75. The method of claim 73 or 74, wherein recycling the non-target ions from the retentate comprises nanofiltration.

76. The method of any one of claims 1-75, further comprising separating a second target cation from the decomplexed solution.

77. The method of claim 76, further comprising separating a third target cation from the decomplexed solution.

78. The method of any one of claims 1-77, wherein decomplexing the precursor with the acid solution further comprises applying at least one stimulus selected from heating, stirring, and ultrasonication.

79. The method of claim 78, wherein adding the at least one stimulus comprises heating.

80. The method of claim 78 or 79, wherein adding the at least one stimulus comprises stirring.

81. The method of any one of claims 78-80, wherein adding the at least one stimulus comprises applying an ultrasonication stimulation frequency.

82. The method of claim 81, wherein the ultrasonic stimulation frequency is from about 18 kHz to about 2000 kHz.

83. The method of claim 82, wherein the ultrasonic stimulation frequency is from about 20 kHz to about 40 kHz.

84. The method of claim 82, wherein the ultrasonic stimulation frequency is from about 800 kHz to about 1200 kHz.

85. The method of claim 81, wherein the ultrasonic stimulation frequency is greater than or equal to about 18 kHz.

86. The method of claim 81, wherein the ultrasonic stimulation frequency is less than or equal to about 2000 kHz.

87. The method of claim 82, wherein the ultrasonic stimulation frequency is about 20 KHz.

88. The method of claim 82, wherein the ultrasonic stimulation frequency is about 30 KHz.

89. The method of claim 82, wherein the ultrasonic stimulation frequency is about 40 kHz.

90. The method of claim 82, wherein the ultrasonic stimulation frequency is about 50 KHz.

91. The method of claim 82, wherein the ultrasonic stimulation frequency is about 60 KHz.

92. The method of claim 82, wherein the ultrasonic stimulation frequency is about 70 kHz.

93. The method of claim 82, wherein the ultrasonic stimulation frequency is about 80 KHz.

94. The method of claim 82, wherein the ultrasonic stimulation frequency is about 90 KHz.

95. The method of claim 82, wherein the ultrasonic stimulation frequency is about 100 kHz.

96. The method of claim 82, wherein the ultrasonic stimulation frequency is about 200 kHz.

97. The method of claim 82, wherein the ultrasonic stimulation frequency is about 300 KHz.

98. The method of claim 82, wherein the ultrasonic stimulation frequency is about 400 KHz.

99. The method of claim 82, wherein the ultrasonic stimulation frequency is about 500 kHz.

100. The method of claim 82, wherein the ultrasonic stimulation frequency is about 600 kHz.

101. The method of claim 82, wherein the ultrasonic stimulation frequency is about 700 kHz.

102. The method of claim 82, wherein the ultrasonic stimulation frequency is about 800 KHz.

103. The method of claim 82, wherein the ultrasonic stimulation frequency is about 900 kHz.

104. The method of claim 82, wherein the ultrasonic stimulation frequency is about 1.0 MHz.

105. The method of claim 82, wherein the ultrasonic stimulation frequency is about 1.1 MHz.

106. The method of claim 82, wherein the ultrasonic stimulation frequency is about 1.2 MHz.

107. The method of claim 82, wherein the ultrasonic stimulation frequency is about 1.3 MHz.

108. The method of claim 82, wherein the ultrasonic stimulation frequency is about 1.4 MHz.

109. The method of claim 82, wherein the ultrasonic stimulation frequency is about 1.5 MHz.

110. The method of claim 82, wherein the ultrasonic stimulation frequency is about 1.6 MHz.

111. The method of claim 82, wherein the ultrasonic stimulation frequency is about 1.7 MHz.

112. The method of claim 82, wherein the ultrasonic stimulation frequency is about 1.8 MHz.

113. The method of claim 82, wherein the ultrasonic stimulation frequency is about 1.9 MHz.

114. The method of claim 82, wherein the ultrasonic stimulation frequency is about 2.0 MHz.

115. A system for extracting and isolating a target cation comprising:
an electrolysis unit comprising:
a catholyte chamber and an anolyte chamber
a permeate inlet;
an acidic solution outlet;
a basic solution outlet;
an anolyte gas outlet; and
a catholyte gas outlet;
a decomplexation tank comprising:
an acidic solution inlet coupled to the acidic solution outlet of the electrolysis unit;
a precursor solution inlet;
an additive inlet; and
a decomplexed solution outlet; and
a cation separation unit comprising:
a decomplexed solution inlet coupled to the decomplexed solution outlet;
a retentate chamber coupled to the decomplexed solution inlet;
a permeate chamber coupled to a permeate outlet;
a retentate outlet coupled to the retentate chamber; and
a separator comprising a separation membrane selective for the passage of a target cation as defined in any one of claims 15-17.

116. The system of claim 115, further comprising a recycle loop feed coupled to the additive inlet and to the retentate outlet.
